(19) United States
(12) Patent Application Publication
(10) Pub. No.: US 2003/0036911 A1
(43) Pub. Date: Feb. 20, 2003

(54) TRANSLATING METHOD AND MACHINE FOR RECORDING TRANSLATION OF A LIST OF PHRASES AND PLAYING BACK TRANSLATIONS LOF PHRASES AS SELECTED BY AN OPERATOR

(76) Inventor: LEE M.E. MORIN, PENSACOLA, FL (US)

Correspondence Address: OFFICE OF NAVAL RESEARCH, OFFICE OF COUNSEL, 800 NORTH QUINCY STREET, ARLINGTON, VA, 22217-5660, US

(21) Appl. No.: 08/200,049

(22) Filed: Feb. 22, 1994

(51) Int. Cl. G06F 17/60

(52) U.S. Cl. 705/1

(57) ABSTRACT

A computer-based device for providing spoken translations of a predetermined set of medical questions, upon the selection of individual questions. Translations are prerecorded into a number of languages, and the physician user, in cooperation with the patient, chooses the language into which the translations are made. Then the physician chooses the questions in the physician's own language that should be asked, then indicates his choice to the device, and the device speaks the corresponding questions in the language of a potential respondent.

### GOVERNMENT INTEREST

The invention described herein may be manufactured, used, and/or licensed by or for the United States Government for governmental purposes without the payment of any royalties thereon.

### BACKGROUND OF THE INVENTION

1. Field OF THE Invention

This invention provides a method and apparatus for providing interpretation into a chosen one of a plurality of languages for a structured interview, especially the type of interview done by a medical professional (hereafter called the physician, the operator, or the user) with a patient who does not share a common language, without the necessity of a human interpreter, and without the necessity of the person being interviewed (hereafter called the patient or the respondent) being able to read or write in any language. The terms translation and interpretation are used interchangeably herein.

Medical history taking, physical examination, diagnostic procedures, and treatment all involve verbal communication to some degree. With rapid world-wide travel now being common, patients are often presented to physicians for care who do not have a common language with the physicians. While it is in this context that the inventor approached the problem, the invention could also be used between confessor and penitent, waiter and customer, hotel desk clerk and international customers, or in other situations where multiple unknown languages must be dealt with.

The use of a human interpreter is a good solution to the physician/patient interview, but it has drawbacks. An interpreter may not be available. It may not even be initially clear what language the patient speaks. Interpreters often interfere with the interview process. They may inject their usually poor medical judgment into the interview, or they may be embarrassed by or embarrass the patient with probing personal questions. If the translator is a relative of the patient, embarrassment or outright fabrication of answers may result.

2. Description OF THE Prior Art

In the prior art, phrase books have been used, and a large set of these for many different languages have been compiled by the United States Department of Defense. These have their drawbacks. Where they are written for the physician to attempt to pronounce a transliteration into a language that the physician is not familiar with, they frequently result in lack of understanding. Pointing to a written phrase in a phrase book requires that the patient be literate, and it is often slow.

In U.S. Pat. No. 4,428,733 to Kumat-Misir, a series of question and answer sheets are provided in two languages, with answers given in one language being generally understandable by reference to sheets in the second language. This would be slow, would require a literate patient, and would not allow the physician to choose the next question based upon the response to the previous question.

There have been efforts, such as represented in U.S. Pat. No. 4,984,117 to Rondel et al, to provide a number of phrases and sentences in a single foreign language, with provision for the user to attempt in his own language to select one or more of those phrases, and if his selection is recognized as possible, to play out a recorded foreign language version of what the user selected. In Rondel et al, this selection is made by training the device to recognize the user's voice as a means for making the selection in his own language. This device can operate in only one foreign language unless restructured, and provides no means for questioning a respondent to determine what foreign language would be suitable for an interview. It is also structured to operate only with user voices that it recognizes, making it time consuming at best for a new user to begin using the translator on short notice.

### SUMMARY OF THE INVENTION

The invention provides a translating machine to enable an operator who is fluent in one language to interview a respondent using a predetermined list of available sentences, which may include questions. This assumes that the respondent speaks any one of a plurality of available languages other than the language in which the operator is fluent, and also assumes that the respondent need not be literate in any language. Translations into each of the available languages of each of the available sentences are stored in advance in a digital form which is convertible into an audio waveform. The available language to be used with a particular respondent is chosen. The user selects individual desired sentences from an alphanumerically stored list which is visually presented to the user. Then, as selected by the user, a translation of the chosen sentences are played out in an audio form to the respondent.

These translations into individual foreign languages were obtained and stored in advance from speakers who were fluent in the individual languages. One of the available sentences is visually presented to the speaker for translation and his spoken translation is recorded. It is then played back for the speaker's approval, and if approved is accepted for long-term storage. If not approved, the speaker is given additional opportunities for recording his spoken translation until he is satisfied.

When the device is to be used to interview a potential respondent, if the language spoken by that respondent is uncertain, the user plays samples of seemingly probable languages to the respondent to determine which language the respondent chooses. The user then can limit future translations to a given respondent to a language which the given respondent has chosen from the samples. In general, digital audio sentences sufficient to conduct a medical interview in a large number of languages, approximating 25 or 30, can be stored on one CD-ROM disk of the size currently in wide use.

### BRIEF DESCRIPTION OF THE DRAWINGS

FIG. 1 is a schematic block diagram of a translating machine in accordance with the present invention

FIG. 2 is a schematic block diagram of a machine for recording a series of translations into a given foreign language.

FIG. 3 is a schematic block diagram of an element for use with the device of FIG. 1 for selecting which of a plurality of foreign languages a given respondent is familiar with.

FIG. 4 is a schematic block diagram indicating that a plurality of foreign languages can be stored on and played back from a single CD-ROM.

### DETAILED DESCRIPTION OF THE PREFERRED EMBODIMENT

When a physician wishes to interview a patient, as in an initial examination, there is a standard list of questions, almost a script, that covers most of what has to be asked. Lists of these phrases have long been available in Department of Defense phrase books referred to above. Other than “yes” or “no” answers in a foreign language, the physician will generally have difficulty understanding responses in the foreign language and must depend upon pointing, holding up a proper number of fingers for the answer, and other non-verbal responses.

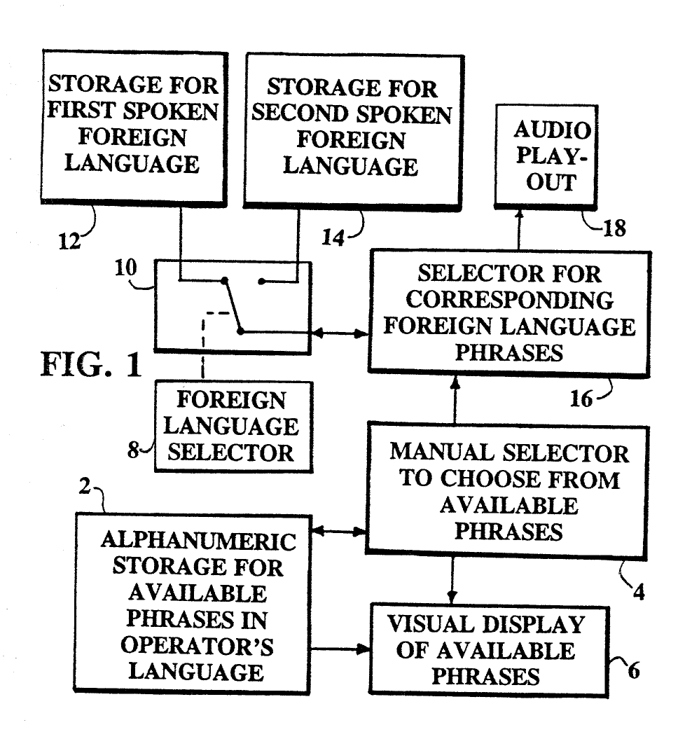

Referring to FIG. 1, which is a schematic block diagram of a translating machine in accordance with the present invention, a storage unit 2 stores an alphabetical list of available phrases in the operator/user's language, and it is possible to move about the available list through the use of a manual selector 4 which can choose among the various available phrases. The phrases available to choose from are displayed to the operator on a visual display of available phrases 6.

The precise method of manually selecting from the available phrases can be chosen from several. It is possible to do a word search by typing in a word such as “appendicitis” and have all available phrases using that word appear on the visual display in order to allow selection of a desired phrase. It is possible to choose, with a mouse or otherwise, from the available phrases being displayed on the visual display in order to select the desired phrase. It is possible to have a script containing a plurality of questions to be asked in sequence (or skipped) as desired for a particular procedure or interview, and to go down that script in order to select the desired phrase.

For the purposes of FIG. 1, it is assumed that, by this time, the foreign language to be used has been selected by operator, using a foreign language selector 8. This can also be operated from a keyboard or with a mouse. Selector 8 operates a logical switch 10, which chooses whether to take the stored spoken foreign language from a storage 12 for a first spoken foreign language, or a storage 14 for a second spoken foreign language.

The choice from the available phrases by the operator from selector 4 goes to a selector 16 for corresponding foreign language phrases. This selector, in connection with logical switch 10, chooses a recorded spoken phrase in the chosen foreign language (the first spoken foreign language with the switch as illustrated) and passes that recorded phrase to an audio playout device 18, where it is played out to be listened to by the respondent/patient.

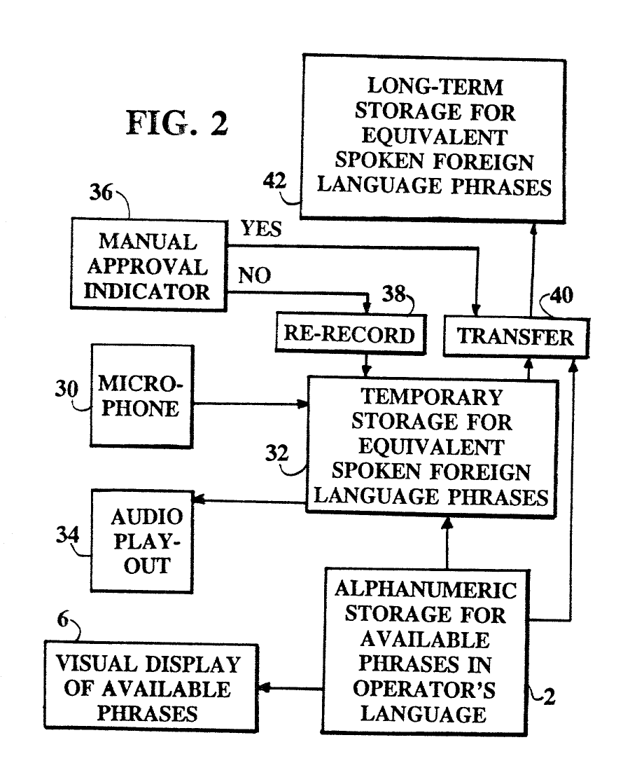

Referring to FIG. 2, which is a schematic block diagram of a machine for recording translations of a series of phrases into a given foreign language, a storage unit 2 is provided for alphanumeric storage of available phrases in the operator's language. The phrases to be translated are presented to the person/speaker who will speak and record the translations on a visual display 6. This speaker is, of course, necessarily knowledgeable in the foreign language to be recorded, unlike the physician/user who is to be the ultimate user of the machine.

When a phrase is presented for translation on display 6, the speaker speaks the translation into microphone 30, from which it is taken and temporarily stored in a temporary storage unit 32 for equivalent spoken foreign language phrases. The recorded phrase is then played back on an audio playout device 34 for the approval of the speaker. The speaker indicates whether or not he approves the translation as played back on manual approval indicator 36. If he does not approve, a re-record control 38 causes the system to accept a new recording of the phrase from the speaker until he gets one he approves. If he does approve of the translation, a transfer control unit 40 causes the temporarily stored phrase from storage unit 32 to be transferred to long-term storage unit 42 for storage as an approved equivalent spoken foreign language phrase.

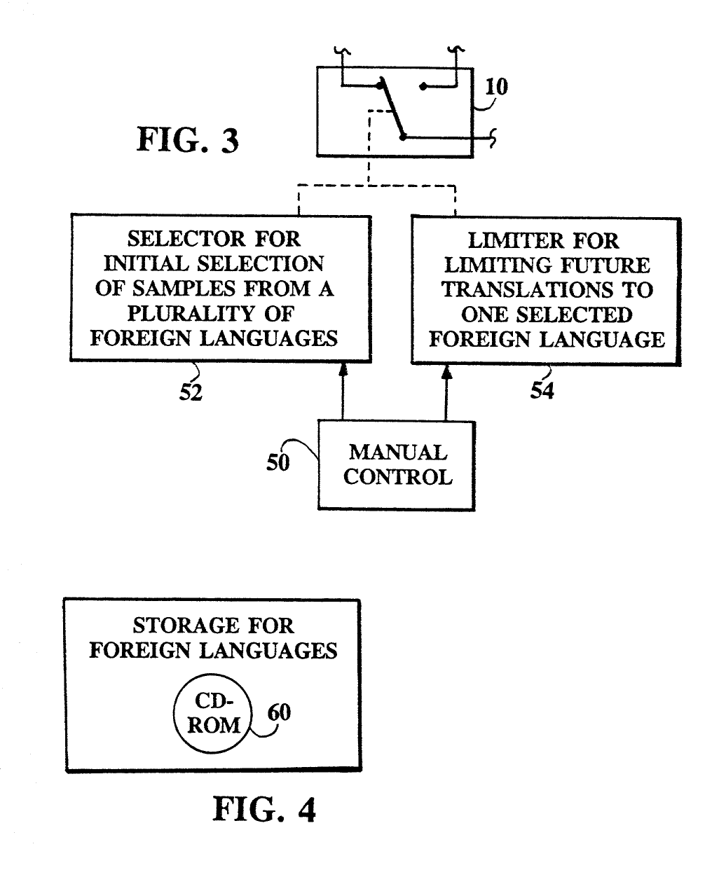

Referring to FIG. 3, which is a schematic block diagram of an element for use with the device of FIG. 1 for selecting which of a plurality of recorded foreign languages a given respondent/patient is familiar with, foreign language selector 8 is shown in more detail in FIG. 3. When a respondent/patient is first presented for interview, if it is not clear what language the respondent understands, manual control 50 is operated to cause a selector 52 to make an initial selection of samples from a plurality of foreign languages. If, for example, a Navy ship picks up a person of oriental appearance from a raft in the ocean off southeast Asia, the operator might choose a series of languages such as Vietnamese, Laotian, Thai, Burmese, etc., to use in the first attempt to find the language of the respondent. In each language in sequence, selector 52 might ask, in that language, “Do you understand this language? If so, say yes.” These questions would be played out to the respondent from the audio playout device 18 of FIG. 1. When a satisfactory language was arrived at, manual control 50 could be used to operate limiter 54 to limit future translations to the one selected foreign language which had been found satisfactory. While switch 10 is shown as a logical switch connected to sources for two foreign languages, many more foreign languages could be connected. When the foreign languages are stored on CD-ROM, as indicated in FIG. 4, phrases and sentences sufficient to conduct a medical interview in up to twenty-five or thirty different foreign languages can be stored on one CD-ROM disk 60, and, of course, a plurality of such disks can be used interchangeably.

It is perfectly possible to construct a special-purpose device containing all of the digital logic to carry out the functions of this invention. However, from the point of economy and ease of operation, the preferred embodiment of the invention uses a personal computer to carry out the function. The system used by the inventor is configured as follows:

An Austin 433VLI Winstation 486 computer with 20 megabytes RAM, two Maxtor hard disk drives respectively holding 130 megabytes and 220 megabytes, a CD drive and soundboard provided by Soundblaster Pro multimedia kit, a Colorado Mountain Jumbo tape backup unit, an SVGA monitor, a Diamond Stealth video board with 1 megabyte of RAM, DOS version 5.0, Windows version 3.1, Norton Desktop version 2.0, WavaWav (Wave after Wave) version 1.5 (a shareware utility allowing sequential audio playback without using Windows) which is available from Ben Salido, 660 West Oak St., Hurst, Tex. 76053-5526, WAVE EDITOR version 1.03 (a shareware utility allowing wave editing, which displays waveform, allowing blocking of the part of a waveform to be retained, thereby reducing required memory, and also allowing amplitude adjustment) available from Keith W. Boone, 114 Broward St., Tallahasse, Fla. 32301, Sony SRS 27 speakers, ACE CAT 5-inch tablet for mouse, and Microsoft Visual Basic version 3.0.

Many variations on this configuration would be possible, but this is the configuration used by the inventor, which is known to be operable. The inventor uses computer programs in Visual Basic, operated under Windows, to run the system. Although these programs are made a part of the file of this application as originally filed, they are not considered to be essential to the invention per se. It is within the skill of those skilled in the art to write such programs as needed, and the programs themselves are not intended for printing with a patent resulting from this application.

When the foreign-language speaker is recording the initial translations, the newly recorded material is originally recorded in RAM, then after approval by speaker is transferred to a hard disk. When the complete set of phrases for a given language are successfully recorded, they are “harvested” from the hard disk and combined with sets of phrases from other languages for permanent recording on a CD-ROM disk. Eventually as many different CD-ROM disks as are needed can be used.

It may be advisable to record all the sample questions needed to find the language spoken by the respondent on one disk for all available languages, to reduce the need from frequent switching of disks as the language is located. It is also possible, when operating in an environment where perhaps five or fewer foreign languages will cover all of the potential respondents, to download those languages from a CD-ROM disk to a hard disk of perhaps 80 megabyte capacity, to avoid necessity of carrying a CD-ROM drive in a portable computer.

It is also desirable to provide the ability to keep a medical history by recording and later printing out a record of the questions asked and the physician's contemporaneous recording of the patient's responses to those question. The system also allows recording a series of phrases as used with one patient, then subsequently editing the phrases in the physician's language to derive a suitable set of phrases for use with later similar patients in any available language. This edited version can include comments which were later added by the editing physician to assist later users. Editing can be done by using the Windows integrated utility Notepad, or by using other word processors, or by using the program which has been written in Visual Basic.

1. A translating machine to enable an operator who is fluent in one language to interview a respondent using a predetermined list of available sentences, which may include questions, where the respondent speaks any one of a plurality of available languages other than the language in which the operator is fluent, and where the respondent need not be literate in any language, comprising:
A. Storage means for advance storage of translations of each of the available sentences in each of the available languages in a form which is convertible into an audio waveform,
B. Means for choosing which of the available languages is to be used with the respondent,
C. Means for storing the predetermined list of available sentences as alphanumeric code,
D. Means for selecting individual desired sentences from the stored predetermined list and displaying them to the operator, and
E. Audio play-out means controllable by the operator for producing an audio output corresponding to selected individual sentence in the chosen language.

2. A machine according to claim 1 further including means for obtaining said translations into any one of said available languages for advance storage in said storage means from a speaker who is fluent in that one available language and in the language in which the operator is fluent, comprising
A. Means for visually presenting one of said available sentences to said speaker for translation,
B. Means for recording a spoken translation of presented sentence as spoken by the speaker,
C. Means for playing back the recorded spoken translation for the approval of the speaker,
D. Means for recording another version of the spoken translation in the event the speaker indicates disapproval of the previously recorded translation, and
E. Means for accepting the recorded version for long-term storage in said storage means in the event the speaker indicates approval of the previously recorded translation.

3. A device according to claim 1 wherein the means for choosing which of the available languages is to be used with the respondent further comprises:
A. Means for playing samples of at least some of the available languages initially to the respondent to determine which language of the available languages can be spoken by the respondent, and
B. Means controlled by the operator for limiting future translations to a given respondent to a language which the given respondent has chosen from the samples as one spoken by the respondent.

4. A device according to claim 1 wherein the storage means comprises a Compact Disk—Read Only Memory (CD-ROM).

5. A method of translating to enable an interviewer who is fluent in one language to interview a respondent using a predetermined list of available sentences, which may include questions, where the respondent speaks any one of a plurality of available languages other than the language in which the interviewer is fluent, and where the respondent need not be literate in any language, comprising the steps of:
A. Digitally storing advance translations of each of the available sentences in each of the available languages in a form which is convertible into an audio waveform,
B. Manually choosing which of the available languages is to be used with the respondent,
C. Digitally storing the predetermined list of available sentences as alphanumeric code,
D. Manually selecting individual desired sentences from the stored predetermined list and displaying them to the interviewer on a viewing display, and
E. Playing out an audio output corresponding to selected individual sentences in the chosen language when manually indicated by the interviewer.

6. A method according to claim 5 further including the method of obtaining said translations into any one of said available languages for advance digital storage from a speaker who is fluent in that one available language and in the language in which the interviewer is fluent, comprising the further steps of
A. Visually presenting one of said available sentences to said speaker on an electronic visual display for translation,
B. Recording a spoken translation of presented sentence as spoken by the speaker,
C. Playing back the recorded spoken translation for the approval of the speaker,
D. Recording another version of the spoken translation in the event the speaker indicates disapproval of the previously recorded translation, and
E. Accepting the recorded version for long-term storage in the event the speaker indicates approval of the previously recorded translation.

7. A method according to claim 5 wherein the step of manually choosing which of the available languages is to be used with the respondent comprises the steps of:
A. Playing samples of at least some of the available languages initially to the respondent to determine which language of the available languages can be spoken by the respondent, and
B. Manually controlling the choice of future translations to limit the language used with a given respondent to a language which the given respondent has chosen from the samples as one spoken by the respondent.
